(19) United States
(12) Patent Application Publication
(10) Pub. No.: US 2022/0111662 A1
(43) Pub. Date: Apr. 14, 2022

(54) HANDHELD PRINTING DEVICE WITH LIGHT SOURCE TO PROJECT LIGHT BOX

(71) Applicant: Hewlett-Packard Development Company, L.P., Spring, TX (US)

(72) Inventors: Matthew Douglas Reier, Vancouver, WA (US); Daniel Ethan Frantz Quarto, Vancouver, WA (US); Chad Quinten Martin, San Diego, CA (US)

(73) Assignee: Hewlett-Packard Development Company, L.P., Spring, TX (US)

(21) Appl. No.: 17/288,526

(22) PCT Filed: Jul. 3, 2019
(86) PCT No.: PCT/US2019/040593

§ 371 Date: Apr. 24, 2021

(51) Int. Cl. B41J 11/00; B41J 3/39; G03B 21/134

(52) U.S. Cl. CPC B41J 11/0095; B41J 3/39; B41J 11/0065; B41J 11/003; G03B 21/134

(57) ABSTRACT

A handheld printing device includes a printing mechanism and a light source. The printing mechanism prints a swath of print material onto a print medium as the handheld printing device is moved across the print medium. The light source projects onto the print medium a light box. The light box has top and bottom edges corresponding to the swath and indicating where the printing mechanism will print the swath as the handheld printing device is moved across the print medium.

### BACKGROUND

Printing devices include multifunction peripherals (MFPs), multifunction devices (MFDs), and all-in-one (AIO) printing devices that combine printing functionality with other functionality, such as scanning, copying, and faxing functionality. Printing devices also include standalone printers that have just printing functionality. Printing devices can use a variety of different technologies, including laser-printing, inkjet-printing, and three-dimensional (3D) printing technologies. Printing devices print using print material, such as colorant like toner and ink (which can include other printing fluids or material as well), and 3D printing material.

### BRIEF DESCRIPTION OF THE DRAWINGS

FIGS. 1A and 1B are top view and front view diagrams, respectively, of an example handheld printing device projecting a light box with a fading trailing edge.

FIG. 2 is a diagram of a print medium having an image that an example handheld printing device may print.

FIG. 3A is a partial front view diagram of an example handheld printing device having a lens for projecting a light box with a fading trailing edge, and FIG. 3B is a diagram of an example lens.

FIG. 4A is a top view diagram of an example handheld printing device projecting a segmented light box. FIG. 4B is a diagram of an example display of an image segmented in accordance with the segmented light box. FIG. 4C is a side view diagram of an example lens for projecting the segmented light box.

FIG. 5A is a top view diagram of an example handheld printing device projecting a light box having a trailing edge corresponding to the trailing image of a swath to be printed. FIG. 5B is a side view diagram of an example lens for projecting this light box.

FIG. 6 is a block diagram of an example handheld printing device.

FIG. 7 is a diagram of an example computer-readable data storage medium for a handheld printing device.

FIG. 8 is a diagram of an example method for a handheld printing device.

### DETAILED DESCRIPTION

As noted in the background, printing device print using print material. For example, two-dimensional (2D) printing technologies involve outputting print material, such as ink or toner, onto print media like paper to form images on the print media. Traditional printing devices—including portable printing devices—remain stationary while the devices print onto print media. For example, sheets of print media may be loaded or fed into the printing devices, with the devices then advancing the media therethrough while outputting print material onto the print media.

The evolution of printing technologies has permitted the introduction of handheld printing devices. Instead of a print medium advancing through a stationary printing device while the device prints on the medium, a handheld printing device can print on a stationary print medium while the device is manually moved across the print medium. For example, a traditional printhead-based printing device, like an inkjet-printing device, may include a carriage that holds one or more printheads, and which moves across a print medium so that the printheads can print a swath of print material on the medium. The print medium is then advanced for the printheads to print the next swath of print material, with this process repeating until the desired image is formed. By comparison, a handheld printing device does not have to include a carriage. Rather, a user may move the printing device across a print medium. In the case of a printhead-based handheld printing device, one more printheads print a swath of print material on the print medium as the user moves the printing device across the medium.

Handheld printing devices can be more convenient to print smaller images on types of print media that may not always be loaded, or that may not be able to be loaded, in more traditional printing devices. For example, handheld printing devices can be more convenient to print addresses and postage indicia on envelopes. Handheld printing devices can print images, including machine-readable codes like barcodes and QR codes as well as other images, on boxes and other print media that cannot be loaded in more traditional printing devices.

However, a user of a handheld printing device may be unable to assess exactly where the printing device will print on a print medium when the user subsequently initiates printing and begins moving the device across the medium. The handheld printing device may be wider than the swath of print material that the printing device can output in a given pass across a print medium, for instance, making it difficult for the user to glean where the swath will be printed on the medium in relation to the printing device's position on the medium. When (and thus where on the print medium) the printing device will actually begin outputting print material after the user starts moving the handheld printing device may similarly not be readily apparent.

Described herein are techniques that ameliorate these issues associated with handheld printing devices. A handheld printing device projects a light box onto a print medium. The light box has top and bottom edges corresponding to the swath of print material that the printing device will print on the print medium as the device is moved across the medium. The light box can have a leading edge indicating where the printing device will begin printing the swath as the device is moved across the print medium.

Therefore, a user is able to see where the printing device will output a swath of print material on a print medium once printing is initiated. The user may move the handheld printing device around the print medium until the printing device projects the light box at a desired printing location on the medium. Once the user has positioned the handheld printing device on the print medium in this manner, the user may initiate the printing process and move the printing device across the medium to cause the device to output print material at the desired printing location.

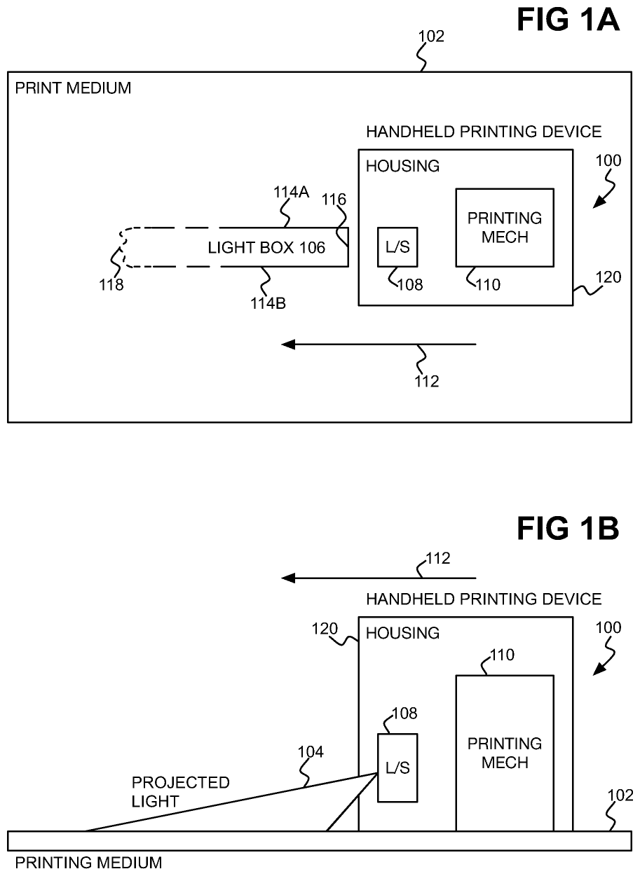

FIGS. 1A and 1B show a top view and a front view, respectively, of an example handheld printing device 100 in relation to a print medium 102, which may be a sheet of paper or another type of print medium. The printing device 100 projects a light box 106 onto the print medium 102. That is, the printing device 100 projects light 104 that forms a box 106 where the light 104 is incident to the medium 102. The light box 106 indicates the location on the print medium 102 at which the printing device 100 will print a swath of print material once printing is initiated and the device 100 is then moved, such as by a user, across the medium 102 in the direction denoted by the arrow 112.

The handheld printing device 100 includes a light source 108 and a printing mechanism 110. The printing device 100 can include other hardware components as well, such as an encoder to measure the distance over which the device 100 is being moved across the print medium 102, an image sensor to capture an image of the medium 102 under or in front of the device 100 as the device 100 is moved across the medium 102, and so on. The light source 108 projects or emits the light 104 that forms the light box 106 where the light 104 is incident to the print medium 102. The light source 108 may include one or more light-emitting elements, such as one or more light-emitting diodes (LEDs).

The printing mechanism 110 can output a swath of print material onto the print medium 102 as the handheld printing device 100 is moved across the medium 102. For instance, the printing mechanism 110 may be an inkjet-printing mechanism, in which case the mechanism 110 can include one or more inkjet cartridges having inkjet printheads. As the handheld printing device 100 is moved across the print medium 102, such an inkjet printhead can eject a swath of ink onto the medium 102. The swath of ink may have a width corresponding to the stack of inkjet nozzles of the printhead. The printing mechanism 110 includes the hardware components of the printing device 100 that output print material onto the print medium 102, and can use a printing technology other than inkjet-printing technology as well.

The light box 106 has a top edge 114A and a bottom edge 114B, which are collectively referred to as the edges 114. The edges 114 are parallel to one another, and correspond to the swath of print material that the printing mechanism 100 will print on the print medium 102 when printing is initiated and the handheld printing device 100 is moved across the medium 102 in the direction indicated by the arrow 112. That is, the distance between the edges 114 of the light box 106 is equal to the width of the print material swath that the printing device 100 will print.

The light box 106 further has a leading edge 116. The leading edge 116 is perpendicular to the edges 114. The leading edge 116 indicates where the handheld printing device 100 will begin printing a swath of material on the print medium 102 when printing is initiated and the printing device 100 is moved across the medium in the direction indicated by the arrow 112. The leading edge 116 can be sharp, providing a clear visible delineation of where printing will begin.

The projected light 104 naturally fades or diffuses with distance from the handheld printing device 100, as indicated by the edges 114 seguing from solid to dashed lines in FIG. 1A. That is, the light box 106 is brightest at the leading edge 116, and then decreases in brightness until the trailing edge 118 thereof is not clearly visibly discernable with a degree of sharpness. The light box 106 can thus be considered as having a fading trailing edge 118 in the example of FIGS. 1A and 1B.

The handheld printing device 100 further includes a housing 120 in which the light source 108 and the printing mechanism 110 are disposed. The light source 108 can be configured to minimize the distance between the leading edge 116 of the light box 106 and the housing 120. This permits for easier usage of the handheld printing device 100 relative to the print medium 102, in that the printing device 100 can be positioned on the medium 102 closer to where printing is desired.

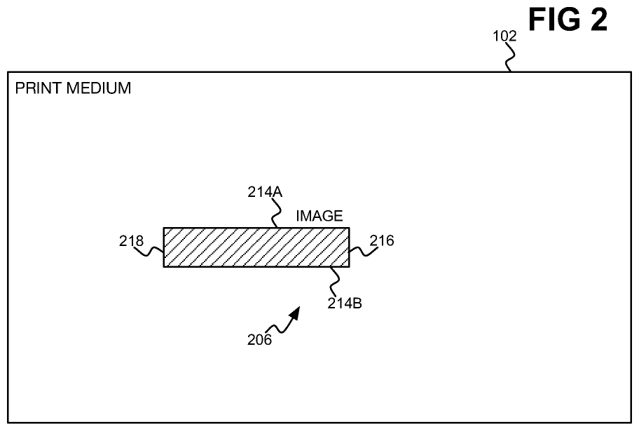

FIG. 2 shows an example image swath 206 that the handheld printing device 100 can print on the print medium 102 after printing has been initiated and as the printing device 100 has been moved across the medium 102. The location of the image swath 206 on the print medium 102 in FIG. 2 corresponds to the location of the light box 106 on the print medium 102 in FIG. 1A. The image swath 206 has edges 214A and 214B, which are collectively referred to as the edges 214, and which are parallel to one another. The image swath 206 has a leading edge 216 and a trailing edge 218.

The edges 114 of the light box 106 of FIG. 1A correspond to the edges 214 of the image swath 206 of FIG. 2. The leading edge 116 of the light box 106 corresponds to the leading edge 216 of the image swath 206. However, the trailing edge 118 of the light box 106 of FIG. 1A does not correspond to the trailing edge 218 of the image swath 206 of FIG. 2. That is, the trailing edge 118 of the light box 106 in FIG. 1A does not indicate where printing by the handheld printing device 100 will stop (i.e., at the trailing edge 218 of the swath 206). Rather, as noted above, the trailing edge 118 of the light box 106 is a fading trailing edge as the light box 106 decreases in brightness with increasing distance from the printing device 100.

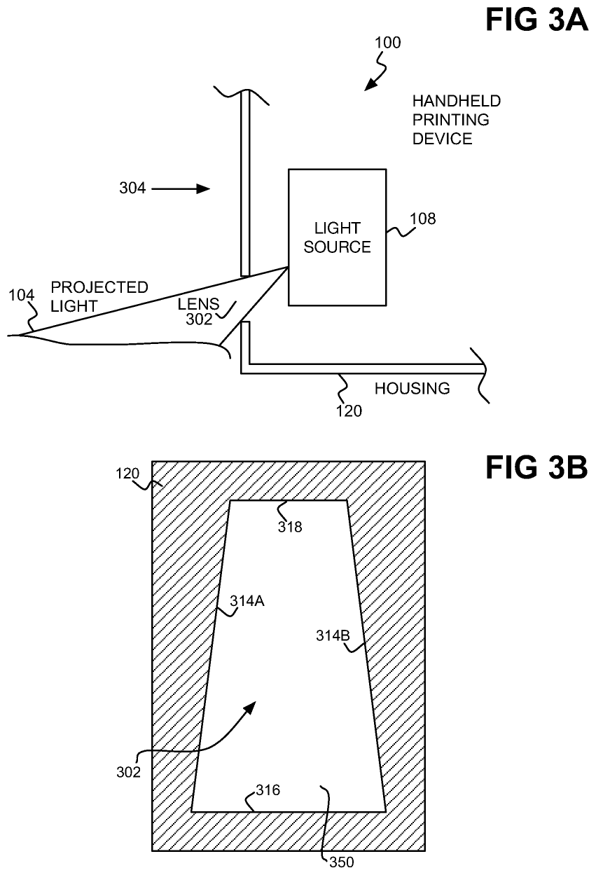

FIG. 3A shows a partial front view of the handheld printing device 100 in example detail. In the example of FIG. 3A, a lens 302 is disposed within the housing 120 of the printing device 100. The light source 108 projects the light 104 through the lens 302 to render the light box 106 on the print medium 102 in FIG. 1A.

FIG. 3B shows a side view of an example lens 302 within the housing 120 in detail, in the direction of the arrow 304 of FIG. 3A. In one implementation, the lens 302 may be an aperture or opening within the housing 120, whereas in another implementation, the lens 302 may be fabricated from a transparent material. The lens 302 thus has a transparent region 350 through which the light source 108 projects the light 104 to form the light box 106 of FIG. 1A. The transparent region 350 is trapezoidal in shape. The long edges 314A and 314B of the region 350, which are collectively referred to as the edges 314, taper from the bottom short edge 316 to the top short edge 318, where the short edge 316 is longer than the short edge 318.

The long edges 314 of the trapezoidal transparent region 350 correspond to the edges 114 of the light box 106 in FIG. 1A. Specifically, the long edge 314A of the transparent region 350 corresponds to the top edge 114A of the light box 106, and the long edge 3146 of the transparent region 350 corresponds to the bottom edge 114B of the light box 106. The edges 314 taper towards one another so that projection of the light 104 by the light source 108 through the lens 302 results in a rectangular light box 106. That is, while the edges 114 of the light box 106 are parallel to one another in FIG. 1A, the edges 314 of the transparent region 350 are not parallel to one another. The bottom short edge 316 of the transparent region 350 corresponds to the leading edge 116 of the light box 106, and the top short edge 318 of the region 350 corresponds to the fading trailing edge 118 of the light box 106.

The lens 302 can be a passive lens or an active lens. In the case of a passive lens 302, the transparent region 350 is fixed. For example, the lens 302 may be formed from a transparent material that is trapezoidal in shape in correspondence with the transparent region 350, surrounded by an opaque material.

In the case of an active lens 302, the transparent region 350 is dynamic. For example, the lens 302 may include a liquid crystal display (LCD) having pixels that can be selectively controlled to be transparent or opaque. Therefore, the LCD can display transparent pixels to render a transparent trapezoid in correspondence with the transparent region 350, surrounded by opaque pixels.

The light box 106 that has been described permits a user to assess where the handheld printing device 100 will print the image swath 206 on the print medium 102 with respect to where printing will start (at the edge 116 of the light box 106), and with respect to the edges 214 of the swath 206 (in correspondence with the edges 114 of the light box 106). However, the user may still be unable to discern where the trailing edge 218 of the image swath 206 will be printed on the print medium 102. This is because the trailing edge 118 of the light box 106 in FIG. 1A does not correspond to the trailing edge 218 of the swath 206 that will be printed.

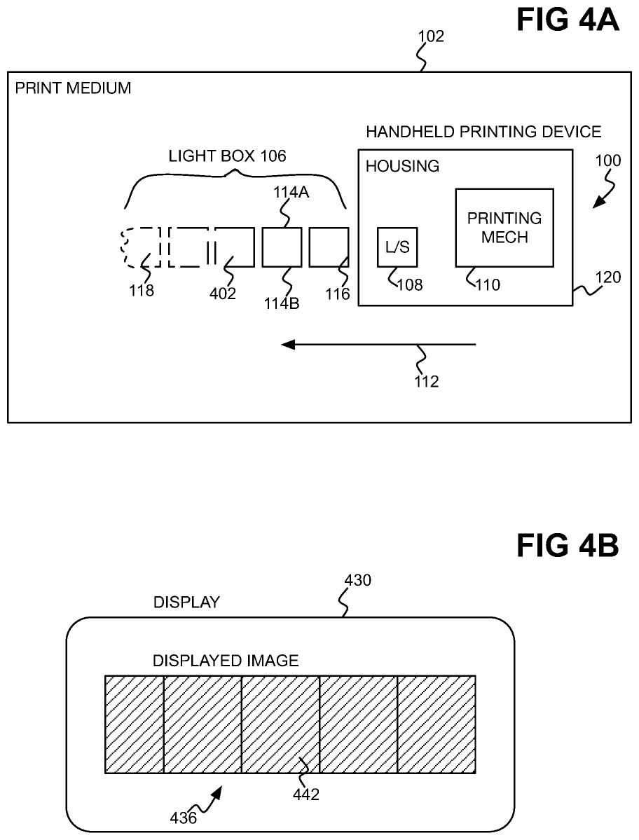

FIG. 4A shows a top view of an example handheld printing device 100 in relation to the print medium 102 and that can permit the user to discern where the trailing edge 218 of the image swath 206 will be printed on the medium 102. As in FIG. 1A, the handheld printing device 100 includes the light source 108 and the printing mechanism 110 disposed within the housing 120. The printing device 100 similarly projects the light box 106 having the edges 114 corresponding to the swath that will be printed once printing is initiated and the device 100 is moved in the direction of the arrow 112. The light box 106 similarly has the leading edge 116 corresponding to where printing will commence, and a fading trailing edge 118, as has been described.

In the example of FIG. 4A, however, the light box 106 is segmented into segments 402. The segments 402 can be equally sized in that they are equal in length along the direction of the arrow 112, until the light box 106 is no longer visible towards the trailing edge 118. The segments 402 provide visual units of measure by which a user can estimate where printing of the image swath 206 of FIG. 2 will end (i.e., the location of the trailing edge 218 on the print medium 102 in FIG. 2), if the user knows how many segments 402 the swath 206 of the desired image will occupy.

FIG. 4B shows an example display 430 of an image 436 that corresponds to the image swath 206 that is ultimately printed on the print medium 102 in FIG. 2. The display 430 may be part of the handheld printing device 100 itself, or may be part of another computing device, such as a smartphone or other such device, that provides the desired image swath 206 to the device 100 for printing. The displayed image 436 is divided into segments 442 on the display 430. The displayed segments 442 correspond to the segments 402 of the light box 106 in FIG. 4A.

The displayed image 436 occupies slightly less than five full segments 442, where the left-most segment 442 is a partial segment. Upon viewing the segmented image 436 on the display 430, the user can then count five corresponding segments 402 of the light box 106 projected in FIG. 4A, starting with the segment 402 closest to the handheld printing device 100, to estimate where printing of the image swath 206 corresponding to the image 436 will end. The user can estimate that the trailing edge 218 of the image swath 206 will be printed on the print medium 102 in FIG. 2 towards the end of the fifth segment 402 of the light box 106 in FIG. 4A, because the corresponding displayed image 436 occupies five segments 442 on the display in FIG. 4B.

FIG. 4C shows a side view of an example lens 302 in detail, in the direction of the arrow 304 of FIG. 3A, to provide for the segmentation of the light box 106 into segments 402 in FIG. 4A. The transparent region 350 of the lens 302 through which the light source 108 projects the light 104 to form the segmented light box 106 of FIG. 4A is again trapezoidal in shape, with long edges 314A and 314B and short edges 316 and 318 as have been described. Furthermore, the lens 302 has opaque segments 454 dividing the transparent region 350 into transparent segments 452 that correspond to the segments 402 of the light box 106. The transparent segments 452 decrease in size and the opaque segments 454 increase in size from the bottom short edge 316 to the top short edge 318 so that projection of the light 104 by the light source 108 through the lens 302 results in the light box 106 having equally spaced and equally sized segments 402.

As has been described, the lens 302 can be a passive lens or an active lens. If the lens 302 is active, the lens 302 renders opaque segments 454 that are dynamic. For instance, an LCD display may display the trapezoidal transparent region 350 as divided by opaque segments 454 in correspondence with the segmentation of the light box 106. If the lens 302 is passive, the opaque segments 454 are fixed as part of the lens 302 itself, in correspondence with the segmentation of the light box 106. In an implementation in which the lens 302 is passive and the light source 108 includes multiple light-emitting units, such as LEDs as noted above, each transparent segment 452 may have its own light-emitting unit(s) that project light just through the segment 452 in question.

The segmented light box 106 of FIG. 4A may not permit a user to precisely assess where printing of the image swath 206 will end in FIG. 2 with the same precision as where printing of the image swath 206 will begin. That is, the segmented light box 106 of FIG. 4A may not permit a user to assess where the trailing edge 218 of the swath 206 will be printed on the print medium 102 with the same precision at which the user can assess where the leading edge 216 of the swath 206 will be printed. The user can assess that the leading edge 216 of the swath 206 will be printed at the leading edge 116 of the segmented light box 106. However, the user may just be able to less precisely assess that the lagging edge 218 of the swath 206 will be printed towards the end of the fifth segment 402 of the light box 106.

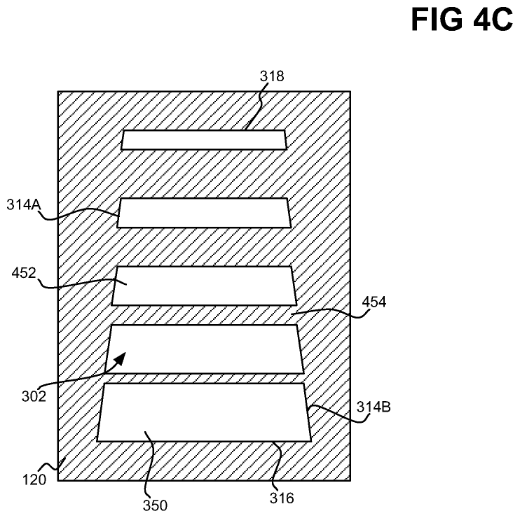

FIG. 5A shows a top view of an example handheld printing device 100 in relation to the print medium 102 and that can permit the user to more precisely discern where the trailing edge 218 of the image swath 206 will be printed on the medium 102. As in FIGS. 1A and 4A, the handheld printing device 100 includes the light source 108 and the printing mechanism 110 disposed within the housing 120. The printing device 100 similarly projects the light box 106 having the edges 114 corresponding to the swath that will be printed once printing is initiated and the device 100 is moved in the direction of the arrow 112. The lightly box 106 similarly has the leading edge 116 corresponding to where printing will commence.

In the example of FIG. 5A, however, the trailing edge 118 of the light box 106 corresponds to where printing will end on the print medium 102. That is, the trailing edge 118 in FIG. 5A corresponds to the trailing edge 218 of the image swath 206 of FIG. 2 that will be printed. The distance between the leading edge 116 and the trailing edge 118 of the light box 106 thus corresponds to the length of the image swath 206 that will be printed, which is the distance between the edges 216 and 218 of the swath 206.

The trailing edge 118 in FIG. 5A is still shown as dotted because the light box 106 will be less bright at the trailing edge 118 than at the leading edge 116. However, the trailing edge 118 in FIG. 5A will be visibly discernable.

This is unlike in FIGS. 1A and 4A, in which the trailing edge 118 is a fading trailing edge because the light box 106 fades with increasing distance from the handheld printing device 100 until the light box 106 is no longer visible.

FIG. 5B shows a side view of an example lens 302 in detail, in the direction of the arrow 304 of FIG. 5A, to provide for the light box 106 having the trailing edge 118 that corresponds to the trailing edge 218 of the image swath 206 that will be printed. The transparent region 350 of the lens 302 through which the light source 108 projects the light 104 to form the light box 106 of FIG. 5A is again trapezoidal in shape, with long edges 314A and 314B and a bottom short edge 316 as have been described. However, the top short edge 318 corresponds to the trailing edge 218 of the image swath 206.

The location of the top short edge 318 is dynamic in correspondence with the length of the image swath 206 that will be printed. The longer the image swath 206 to be printed is, the taller the transparent region 350 is, and thus the farther the top short edge 318 is away from the other short edge 316. Adjusting the height of the transparent region 350 in this respect correspondingly controls the length of the light box 106 in FIG. 5A.

In the example of FIG. 5B, the lens 302 can be an active lens so that the height of the transparent region 350 (i.e., the position of the top short edge 318) can be dynamic in correspondence with the length of the image swath 206 that will be printed. Such an active lens 302 can include an LCD, for instance, as has been described. In this case, the LCD can display transparent pixels to render the trapezoidal transparent region 350 with a top short edge 318 corresponding to the trailing edge 218 of the image swath 206 that will be printed. Usage of the lens 302 of FIG. 5B also permits the light box 106 to be segmented as in FIG. 4C. In another implementation, the lens 302 may be passive as described in relation to FIG. 3B, but include an LCD positioned behind the lens 302 to dynamically vary the height of the transparent region 350 in correspondence with the length of the swath 206 as in the active implementation, effectively rendering the region 350 dynamic as to its top short edge 318.

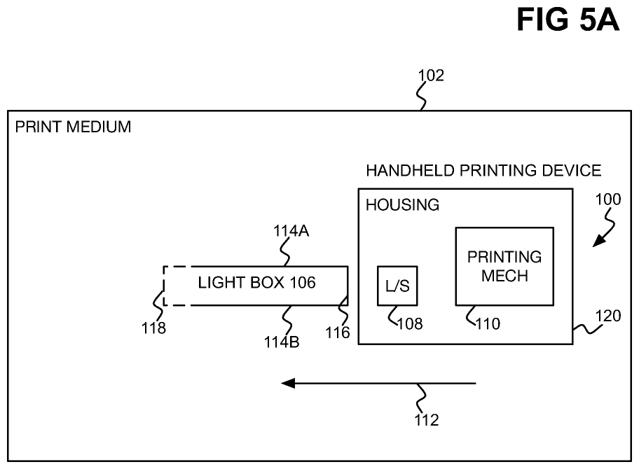

FIG. 6 shows a block diagram of an example handheld printing device 100. The handheld printing device 100 includes a printing mechanism 110 to print a swath of print material onto a print medium as the printing device is moved across the medium, as has been described. The handheld printing device 100 includes a light source 108 to project a light box onto the print medium, as has also been described. As noted above, the light box has top and bottom edges corresponding to the swath and indicates where the printing mechanism 110 will print the swath as the handheld printing device is moved across the print medium, as in FIGS. 1A, 4A, and 5A.

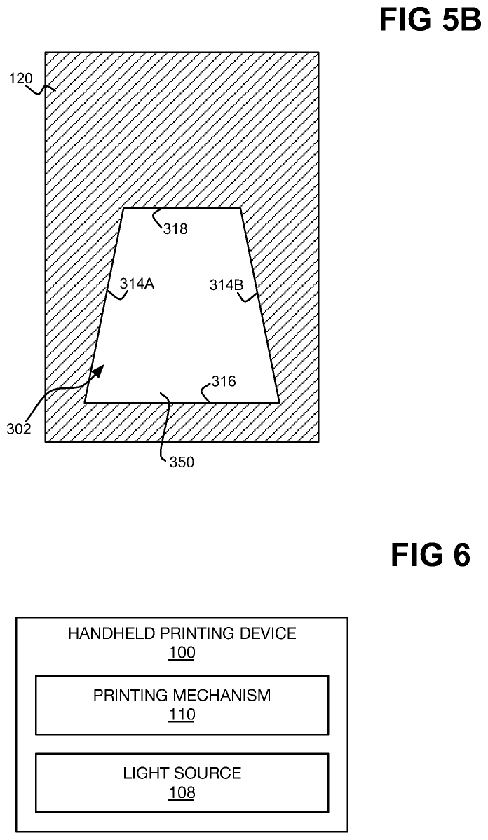

FIG. 7 shows an example non-transitory computer-readable data storage medium 700 storing program code 702 that is executable by a handheld printing device, such as the handheld printing device 100 that has been described. The computer-readable data storage medium 700 may be an application-specific integrated circuit (ASIC) within the handheld printing device and that is encoded with the program code 702. The computer-readable data storage medium 700 in another implementation may be a memory or other storage device that stores the program code 702, which a general-purpose or other processor of the handheld printing device executes.

The handheld printing device executes the program code 702 to cause a light source of the handheld printing device to project onto a print medium a light box having top and bottom edges, as has been described. The printing device executes the program code 702 to cause a printing mechanism of the handheld printing device to print a swath of print material onto the print medium as the handheld printing device is moved across the print medium, as has also been described. As noted above, the light box has top and bottom edges corresponding to the swath and indicates where the printing mechanism will print the swath as the handheld device is moved across the print medium.

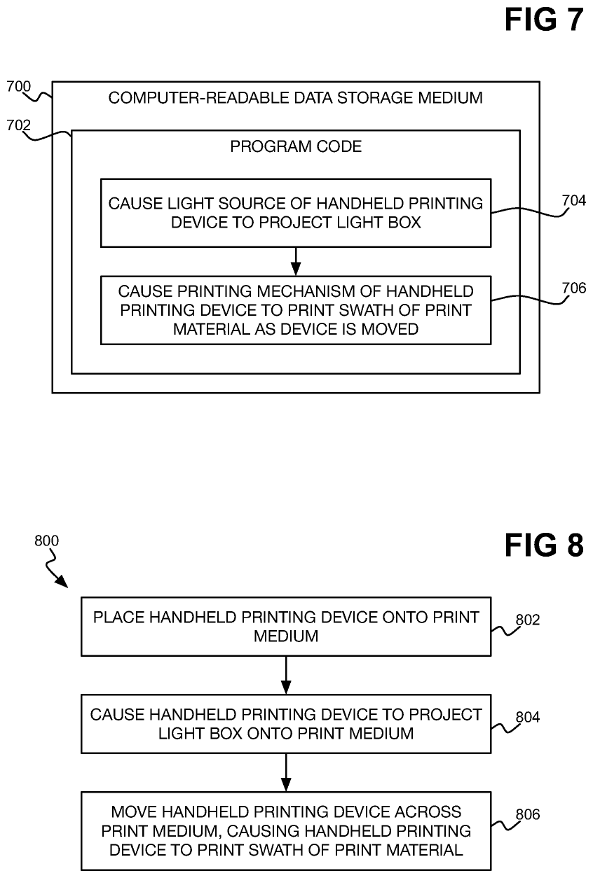

FIG. 8 shows an example method 800. The method 800 includes placing a handheld printing device onto a print medium on which the handheld printing device is to print a swath of print material (802). For example, a user may place the handheld printing device 100 that has been described on a print medium 102 on which the user wishes to print the image swath 206 of FIG. 2.

The method 800 includes causing the handheld printing device to project onto the print medium a light box having top and bottom edges corresponding to the swath and indicating where the handheld printing mechanism will print the swath (804). As an example, once the user has placed the handheld printing device on the print medium, the user may press a button or other control on the printing device to cause the device to project a light box as in FIG. 1A, 4A, or 5A. The user may then reposition the handheld printing device as desired on the print medium until the light box is projected at the location on the medium at which the user wants a print material swath to be printed. The handheld printing device may continue displaying the light box until the user subsequently initiates printing. If the user does not initiate printing within a period of time, the printing device may time out and stop projecting the light box to conserve power.

The method 800 includes moving the handheld printing device across the print medium, which causes the handheld printing device to print the swath as the printing device is moved, at the location at which the light box is projected when the printing process is initiated (806). As an example, once the user has positioned the handheld printing device on the print medium such that the light box is projected at the desired location on the print medium at which the image swath is to be printed, the user may press a button or other control on the printing device to start the printing process. For instance, the user may press and hold the same button that the user previously pressed to cause the printing device to project the light box in part 804, and then release the button once the device has indicated that it has initiated the printing process.

An indicator light may begin flashing once the printing process has been initiated, at which time the user may release the button. Once the handheld printing device has warmed up, indicating that the printing device is ready to print, the device may solidly illuminate the indicator light, signaling to the user that he or she can commence with moving the handheld printing device across the medium, in the direction in which the light box was projected. The printing device then prints the image swath of print material on the print medium as the user moves the device across the medium, at the location at which the light box was projected on the medium at the time the user signaled to the device to initiate the printing process.

Techniques have been described herein for a handheld printing device to project a light box indicating where the printing device will print a swath of print material on a print medium when printing is subsequently initiated and the device is moved across the medium. The light box has top and bottom edges corresponding to the swath, and can have a leading edge indicating where printing will start as the handheld printing device is moved across the print medium. The light box can be segmented, and/or can have a lagging edge that corresponds to where printing of the swath will stop. The techniques thus permit a user to more precisely control where a handheld printing device will print a swath of print material.

We claim:

1. A handheld printing device comprising:
a printing mechanism to print a swath of print material onto a print medium as the handheld printing device is moved across the print medium; and
a light source to project onto the print medium a light box having top and bottom edges corresponding to the swath and indicating where the printing mechanism will print the swath as the handheld printing device is moved across the print medium.

2. The handheld printing device of claim 1, wherein the light box further has a leading edge indicating where the printing mechanism will begin printing the swath as the handheld printing device is moved across the print medium.

3. The handheld printing device of claim 2, wherein the light box further has a trailing, fading edging.

4. The handheld printing device of claim 2, further comprising:
a housing in which the printing mechanism and the light source are disposed,
wherein the light source is configured to minimize a distance between the leading edge of the light box and the housing.

5. The handheld printing device of claim 2, further comprising:
a passive lens through which the light source projects light, the lens having a fixed transparent region corresponding to a trapezoid to form the projected light into the light box,
wherein the trapezoid has first and second short edges that are parallel to one another, the first short edge longer than the second short edge and corresponding to the leading edge of the light box,
and wherein the trapezoid has a pair of long edges corresponding to the top and bottom edges of the light box.

6. The handheld printing device of claim 2, further comprising:
an active lens through which the light source projects light, the active lens to render a dynamic transparent region corresponding to a trapezoid to form the projected light into the light box,
wherein the trapezoid has first and second short edges that are parallel to one another, the first short edge longer than the second short edge and corresponding to the leading edge of the light box,
wherein the trapezoid has a pair of long edges corresponding to the top and bottom edges of the light box.

7. The handheld printing device of claim 2, wherein the light box is segmented into a plurality of segments.

8. The handheld printing device of claim 7, further comprising:
a passive lens through which the light source projects light,
wherein the passive lens has a fixed transparent region corresponding to a trapezoid to form the projected light into the light box,
and wherein the passive lens further has a plurality of fixed opaque segments dividing the fixed transparent region in correspondence with the segments of the light box.

9. The handheld printing device of claim 7, further comprising:
an active lens through which the light source projects light, the active lens to render a dynamic transparent region corresponding to a trapezoid to form the projected light into the light box,
and wherein the active lens is further to render a plurality of dynamic opaque segments dividing the dynamic transparent region in correspondence with the segments of the light box.

10. The handheld printing device of claim 2, wherein the light box further has a trailing edge,
and wherein a distance between the leading edge and the trailing edge corresponds to a length of an image that the printing mechanism is to print within the swath of print material.

11. The handheld printing device of claim 10, further comprising:
a lens through which the light source projects light, the lens to render a dynamic transparent region corresponding to a trapezoid to form the projected light into the light box,
wherein the trapezoid has first and second short edges that are parallel to one another, the first short edge longer than the second short edge and corresponding to the leading edge of the light box, the second short edge corresponding to the trailing edge of the light box,
and wherein the trapezoid has a pair of long edges corresponding to the top and bottom edges of the light box.

12. A non-transitory computer-readable data storage medium storing program code executable by a handheld printing device to:
cause a light source of the handheld printing device to project onto a print medium a light box having top and bottom edges; and
cause a printing mechanism of the handheld printing device to print a swath of print material onto the print medium as the handheld printing device is moved across the print medium,
wherein the light box has top and bottom edges corresponding to the swath and indicating where the printing mechanism will print the swath as the handheld printing device is moved across the print medium.

13. The non-transitory computer-readable data storage medium of claim 12, wherein the light box is segmented into a plurality of segments.

14. The non-transitory computer-readable data storage medium of claim 12, wherein the light box, wherein the light box further has a leading edge and a trailing edge,
and wherein a distance between the leading edge and the trailing edge corresponds to a length of an image that the printing mechanism is to print within the swath of print material.

15. A method comprising:
placing a handheld printing device onto a print medium on which the handheld printing device is to print a swath of print material;
causing the handheld printing device to project onto the print medium a light box having top and bottom edges corresponding to the swath and indicating where the handheld printing device will print the swath; and
moving the handheld printing device across the print medium, causing the handheld printing device to print the swath as the handheld printing device is moved.
